(19) United States
(12) Patent Application Publication
(10) Pub. No.: US 2005/0269372 A1
(43) Pub. Date: Dec. 8, 2005

(54) Vented dispensing package

(76) Inventor: Roger P. Smith, Perrysburg, OH (US)

Correspondence Address: VENABLE LLP, P.O. BOX 34385, WASHINGTON, DC, 20045-9998, US

(21) Appl. No.: 10/862,241

(22) Filed: Jun. 7, 2004

(51) Int. Cl. B67D 3/00

(52) U.S. Cl. 222/481.5

(57) ABSTRACT

A package for dispensing a viscous product includes a container having an end wall, a resilient sidewall, and a finish to which a skirt of a dispensing closure is attached. The closure includes a base wall having a discharge opening and an adjacent vent opening. A valve body extends from the base wall and includes a through passage aligned with the vent opening. A check valve is disposed within the valve body, and a tube includes a first end attached to the valve body and extends from the fixed end toward the end wall of the container, and terminates in an open second end adjacent to the end wall of the container. The check valve functions when the container is squeezed to prevent air passage out the vent opening, and functions when the container is released to permit air passage through the vent opening and the tube.

The present invention is directed to dispensing packages for fluid products such as a viscous liquid product, and more particularly to a squeeze tottle package wherein the viscous liquid product is dispensed by squeezing a sidewall of a squeeze tottle container.

### BACKGROUND AND SUMMARY OF THE INVENTION

Squeeze container packages are widely known and used for containing and dispensing a wide variety of fluent and viscous liquid products, such as body lotions. Squeeze container packages typically include a squeeze container having a flat base adapted for resting the container in an “upright” orientation that is substantially opposite of the dispensing orientation in which the squeeze container is actually used. A sidewall of the container extends from the base wall and terminates in a finish portion that has an opening and that is adapted to receive a dispensing closure of desired shape. In the upright orientation and with the closure in a closed position to seal the package, the viscous product rests on the base within the container and air is trapped in the head space between the viscous product and the closed closure. To dispense the viscous product, the squeeze container package is first inverted from its upright position wherein the viscous product and the air exchange places, such that the viscous product flows toward the opening of the container under the force of gravity, thereby displacing the air to a position between the viscous product and the base of the container. A user opens the closure and squeezes the sidewall of the container to reduce the interior volume of the package, thereby forcing the viscous product out of the closure. When finished dispensing, the user releases pressure from the sidewall and reorients the package in the upright position such that the remaining viscous product flows back toward the base of the container and “make up” air is permitted to vent through the discharge opening and into the container, thereby normalizing the atmospheric pressure in the container to permit the sidewall to recover its original shape. Thereafter, the closure is closed until the next use. The fresh air is termed “make up” air because it makes up or compensates for the displacement and lost volume of the viscous product. One disadvantage with such a dispensing package is that it is not continuously ready for immediate dispensing of the viscous product and first must be inverted to induce the viscous product to flow toward the opening.

In contrast to such squeeze container packages, squeeze tottle packages are becoming increasingly popular for dispensing viscous products such as liquid soap and shampoo. Squeeze tottle packages are sleekly styled dispensing packages that include a squeeze tottle, which typically does not include a flat base but instead includes a rounded end wall that is incapable of supporting the package in an upright position. A sidewall of the tottle extends from the end wall and terminates in a finish portion that has an opening and that is adapted to receive a dispensing closure. The closure includes a flat end adapted for resting the package in an orientation that is substantially the same as its intended dispensing orientation—in contrast to the upright resting orientation of a squeeze container package. In its normal dispensing orientation, and with the closure in a closed position to seal the tottle package, the viscous product rests in the finish portion of the tottle and the dispensing closure, and a head of air is trapped between the viscous product and the end wall of the tottle. One advantage of such a dispensing package is that the viscous product contained therein is always immediately adjacent the discharge opening and is thus continuously ready for quick dispensing without having to invert the package. To dispense the viscous product, a user opens the closure and squeezes the sidewall of the squeeze tottle to reduce the interior volume thereof, thereby forcing the viscous product out of the dispensing opening. When finished dispensing, the user releases pressure from the sidewall, closes the closure, and rests the squeeze tottle package on the flat base of the closure until the next use.

Unfortunately, however, the typical squeeze tottle package does not readily permit a fresh supply of make up air to vent into the container between uses, especially where the viscous product is a thick fluid such as shampoo. This inability to vent leads to at least two disadvantages. First, the lack of a fresh supply of air yields an attendant vacuum condition within the interior of the tottle such that the sidewall of the tottle cannot recover its original shape and, thus, exhibits a relatively unattractive distorted appearance. Second, because the sidewall is fixed in its collapsed state, it is difficult to further collapse the sidewall so as to expel more viscous product from the tottle. One solution to these problems is to provide the tottle with a relatively thicker and more rigid sidewall to increase the hoop strength and resiliency thereof to overcome the resistance to venting imposed by the viscous product. Unfortunately, this solution involves added material expense and limits the material selection options of the container designer. Another solution to these problems is to burden the user to invert the squeeze tottle package after each use so as to permit the package to vent a fresh charge of air therein, vis-à-vis the typical function of the squeeze bottle package described above. Unfortunately, this solution defeats one of the advantages of using the tottle-type package.

A package for dispensing a viscous product in accordance with one aspect of the invention includes a container and a closure adapted for attachment thereto. The container includes an end wall, a sidewall of flexible resilient construction extending forward from the end wall and terminating in a finish to which the closure is attached. The closure includes a base wall and at least one skirt extending therefrom for securement to the finish of the container. The base wall includes a product discharge opening and a vent opening adjacent to the discharge opening. A valve body extends from the base wall and includes a through passage in communication with the vent opening in the base wall. A check valve is disposed within the valve body, and a tube includes an end attached to the valve body. The tube extends from the end toward the end wall of the container and terminates in an opposite end adjacent to the end wall of the container. The check valve functions when the container is squeezed to prevent air passage through the tube, the valve body and the vent opening. The check valve further functions when the container is released to permit air to pass through the vent opening, the valve body and the tube into the package.

In accordance with a second aspect of the invention, there is provided a method of dispensing a fluid product from a squeeze tottle package, wherein a tottle container is provided in which the fluid product is contained, and further wherein a tottle closure is provided on the tottle container. A vent opening in at least one of the tottle closure and the tottle container is fluidically communicated to a location adjacent the end wall of the tottle container. Air is permitted to vent through the vent opening into the tottle container, and air and the fluid product are prevented from escaping out the vent opening.

### BRIEF DESCRIPTION OF THE DRAWINGS

The invention, together with additional objects, features, advantages and aspects thereof, will be best understood from the following description, the appended claims and the accompanying drawings, in which:

FIG. 1 is a perspective view of a squeeze dispensing package according to one exemplary embodiment of the present invention;

FIG. 2 is a fragmentary sectional view of the squeeze dispensing package of FIG. 1 taken substantially along line 2-2 thereof;

FIG. 3 is an exploded view of the portion of the closure, valve and vent tube of FIG. 4;

FIG. 4 is an enlarged view of a portion of a closure, valve and vent tube of FIG. 2; and

FIG. 5 is a perspective view of the vent tube of FIG. 4.

### DETAILED DESCRIPTION OF PREFERRED EMBODIMENTS

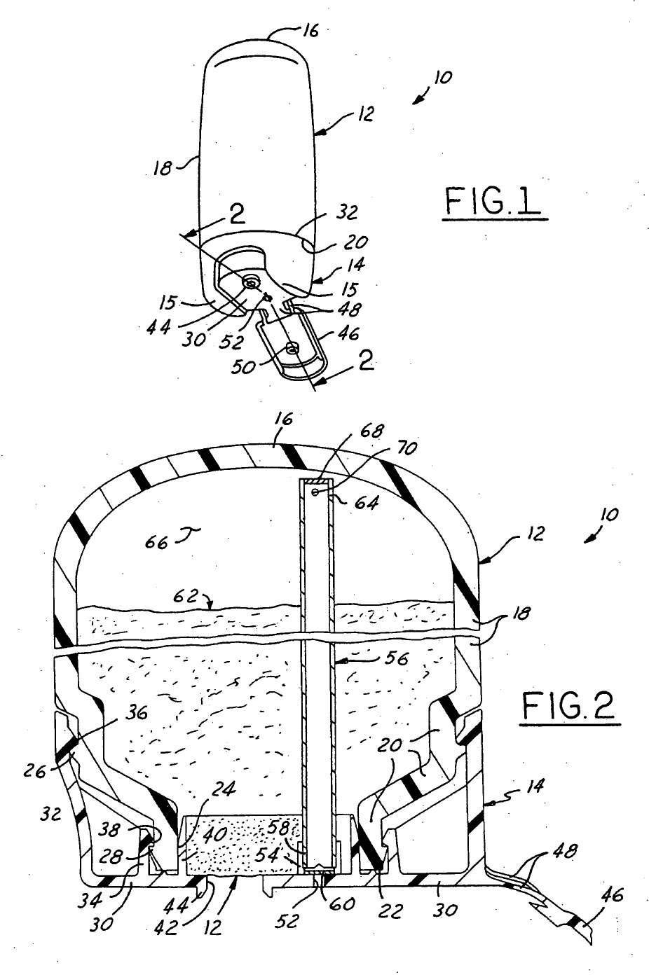

FIGS. 1 and 2 illustrate a squeeze dispensing package 10 according to an exemplary embodiment of the present invention. The squeeze dispensing package 10 is, more specifically, a squeeze tottle package including a tottle container 12 and a tottle dispensing closure 14 attached thereto, wherein the tottle closure 14 includes a flat surface 15 for resting the package 10 thereon. The tottle container 12 may be composed of a light weight flexible resilient material, such as soft-touch polypropylene (PP), low density polyethylene (LDPE) or the like, and may be produced by any desired method including blow molding a preform, blow molding an extruded parison or the like. The container 12 includes a rounded end wall 16 and a sidewall 18 extending longitudinally forward from the end wall 16. As best shown in FIG. 2, the side wall 18 terminates in a finish portion 20 that includes a transverse end 22 defining an opening 24 of the container 12. The finish portion 20 also includes first and second radially outwardly extending annular beads 26, 28 for engaging the tottle closure 14.

Still referring to FIGS. 1 and 2, the exemplary dispensing closure 14 is a dual-skirt design that is popular with tottle packages so that the outer profile of the closure 14 blends with the outer profile of the container 12. The closure 14 may be composed of any desired polymer or copolymer including PP, LP, polycarbonate (PC), polyethylene terephthalate (PET) and the like, and may be produced by any desired process including injection molding or the like. The closure 14 includes a base wall 30 having a circumferentially continuous exterior skirt 32 and a circumferentially continuous interior skirt 34 extending from the base wall 30. The skirts 32, 34 include first and second radially inwardly extending helical thread segments or annular beads 36, 38 for engaging the corresponding external thread segments or beads 26, 28 of the container 12 so as to retain the closure 14 to the container 12. The closure 14 further includes an annular skirt seal 40 extending from the base wall 30 into an internal interference fit with the opening 24 of the container 12. A discharge opening 42 is provided in the base wall 30 and is surrounded by an annular valve seat 44. A closure lid or flap 46 is shown in an open position and is flexibly hinged to the base wall 30 at one side thereof by a hinge 48. As best shown in FIG. 1, the closure flap 46 includes a valve 50 for sealing against the annular valve seat 44 of the base wall 30 so as to seal the discharge opening 42 when the closure flap 46 is closed. Also, the back of the closure flap 46 partially defines the flat surface 15 of the tottle closure 14 when closed.

As shown in FIG. 2, the base wall 30 also includes a vent opening 52 therethrough and an annular collar-shaped wall or valve body 54 extending inwardly therefrom. A vent tube 56 includes a first end 58 disposed within the valve body 54, and a check valve in the form of a disk valve 60 is disposed between the vent tube 56 and the base wall 30. The vent tube 56 extends from the valve body 54, through a supply of viscous liquid 62, and terminates in a second end 64 adjacent the end wall 16 of the container 12 in an air space 66 between the viscous liquid 62 and the end wall 16. As used herein, the term viscous means any liquid that is higher in viscosity than water, and more specifically is representative of any of a number of viscous personal care or food products such as shampoo, moisturizing lotion, mustard, ketchup, and the like. To minimize clogging of any viscous liquid within the vent tube 56, the second end 64 of the vent tube 56 is provided with a closed transverse end 68 and one or more lateral vent openings 70 through the side of the vent tube 56. The vent tube 56 may be composed of any desired material, such as PP, LDPE, PC, PET or the like, and may be produced by injection molding or the like. The disk valve 60 may be produced from any desired material, such as silicone or the like, and may be injection molded, cut from sheet or bar stock, or the like.

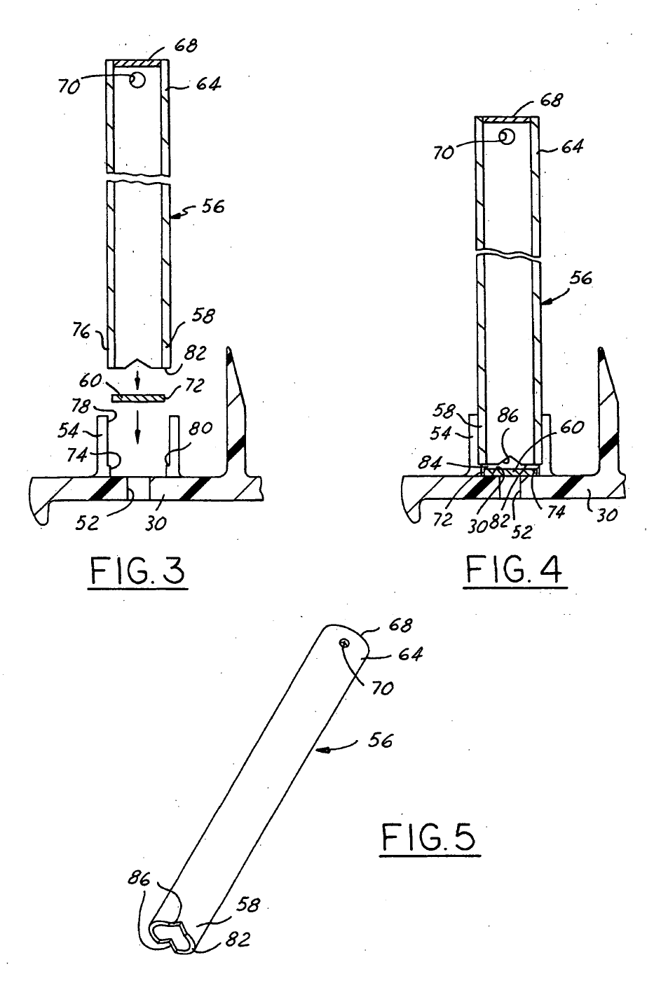

FIGS. 3 and 4 are enlarged views of the valving arrangement. FIG. 3 illustrates the assembly of the freely located disk valve 60 within the confines of the valve body 54 and the first end 58 of the vent tube 56 within the confines of the valve body 54. The disk valve 60 is inserted into the valve body 54 until it rests on the base wall 30 of the closure 14, and the disk valve 60 has an outer diameter 72 that is sized to be slightly smaller than a first inner diameter 74 of the valve body 54 so as to provide a loose fit therebetween for permitting incoming make up air to pass therebetween. The first end 58 of the vent tube 56 includes an outer diameter 76 that is slightly larger than a second inner diameter 78 of the valve body 54, such that a sealing interference fit is established when the vent tube 56 is inserted into the valve body 54. The valve body 54 also includes an interior shoulder portion 80 for controlling the location of an open transverse end 82 of the vent tube 56 with respect to the base wall 30, such that the disk valve 60 is free to float longitudinally between the base wall 30 and the open transverse end 82 of the vent tube 56, as better shown in FIG. 4. FIG. 4 illustrates that a space 84 is provided between the open transverse end 82 of the vent tube 56 and the base wall 30 that is large enough to accommodate longitudinal displacement of the disk valve 60 therebetween.

FIG. 5 illustrates reliefs or V-notches 86 formed in the open transverse end 82 at the first end 58 of the vent tube 56. At the opposite second end 64, the vent opening 70 is shown as a circular hole provided adjacent the closed transverse end 68 of the vent tube 56.

Referring again to FIG. 4, one of ordinary skill in the art will appreciate that air may flow into the vent opening 52 of the base wall 30 of the closure 14 so as to displace the disk valve 60 flat against the open transverse end 82 of the vent tube 56. Accordingly, the disk valve 60 is provided with a predetermined thickness so as to be rigid and not to conform into the V-notches 86. Moreover, it can be appreciated that the flow of air can continue around the outer diameter 72 of the disk valve 60 within the first inner diameter 74 of the valve body 54, and between the flat disk valve 60 and the V-notches 86 into the vent tube 56, through the vent tube 56 toward the opposite end 64 thereof, and out the outlet vent opening 70.

Referring again to FIG. 2, one of ordinary skill in the art will recognize the advantageous functionality of the structure just previously described with respect to FIG. 4. With the present invention, it is now possible to vent make up air into the interior of the squeeze tottle package 10 while the package 10 is in its normal dispensing orientation as shown. In the normal dispensing orientation, the viscous product 62 rests on the finish portion 20 of the tottle container 12 and on the closure 14, and a head of air is trapped in the air space 66 between the viscous product 62 and the end wall 16 of the tottle container 12. As mentioned previously, an advantage of such a dispensing package 10 is that the viscous product 62 contained therein is immediately adjacent the discharge opening 42 and is thus continuously ready for quick dispensing without having to invert the package 10. To dispense the viscous product 62, a user squeezes the sidewall 18 of the squeeze tottle 12 to reduce the interior volume thereof, thereby compressing the head of air in the air space 66 to force the viscous product 62 out of the discharge opening 42. After each dispensing cycle, the user releases pressure from the sidewall 18 of the container 12, thereby partially enabling the resilient sidewall 18 to flex outwardly toward its original shape under the inherent resilient “memory” of the container 12. This creates a vacuum in the air space 66 that tends to lift the disc valve 60 off of the vent opening 52 and that draw a fresh charge of make up air through the vent opening 52, past the check valve 60, through the vent tube 56, and into the tottle container 12 in the air space 66 behind the viscous product 62. Thereafter, the user can close the closure flap 46 of the closure 14, and rest the squeeze tottle package 10 on the flat base 15 of the closure 14 until the next use. In this way, the air space 66 is permitted to fill with make up air after each dispensing cycle so that the inherent resiliency of the container sidewall 18 will return the container 12 to its freestanding original shape.

There have thus been described a package and method for dispensing a viscous product that fully satisfy all of the objects and aims previously set forth. The present invention has been disclosed in conjunction with presently preferred embodiments thereof, and a number of modifications and variations have been discussed. Other modifications and variations will readily suggest themselves to persons of ordinary skill in the art in view of the foregoing description. Directional words such as upright, inverted, top, bottom, upper, lower, radial, circumferential, and the like are employed by way of description and not limitation. Indeed, the invention is intended to embrace all modifications and variations as fall within the spirit and broad scope of the appended claims.

1. A package for dispensing a fluid product, which includes:
a container having an end wall, a sidewall of flexible resilient construction extending forward from said end wall and terminating in a neck finish, and
a dispensing closure adapted for attachment to said finish of said container, said closure including:
a base wall and at least one skirt extending therefrom for securement to said neck finish of said container, said base wall having a product discharge opening and a vent opening adjacent to said product discharge opening,
a valve body extending from said base wall, said valve body having a through passage in communication with said inlet vent opening in said base wall,
a check valve in said valve body, and
a tube having an end attached to valve body, said tube extending from said end toward said end wall of said container and terminating in an opposite end adjacent to said end wall of said container,
said check valve functioning when said container is squeezed to prevent air passage through said tube, said valve body, and said inlet opening, said check valve further functioning when said container is released to permit air to pass through said vent opening, said valve body, and said tube into said package.

2. The package set forth in claim 1 wherein said container is a tottle.

3. The package set forth in claim 1 wherein said check valve is a disk.

4. The package set forth in claim 3 wherein a first end of said tube is disposed within said through passage of said valve body and said first end terminates in an open transverse end such that a space is defined between said open transverse end of said tube and said base wall of said closure, further wherein said disk is freely located in said space such that said disk can locate against said base wall to cover said vent opening and such that said disk can locate against said transverse end of said tube.

5. The package set forth in claim 4 wherein said first end of said tube has at least one relief formed therein so as to permit air to vent through said vent opening, around said disk, within said valve body, through said at least one relief, through said tube, and out a second end of said tube.

6. The package set forth in claim 5 wherein said second end of said tube includes a closed transverse end and at least one lateral opening adjacent said closed transverse end.

7. A method for dispensing a fluid product from a squeeze tottle package, including:
providing a tottle container in which said fluid product is contained,
providing a tottle closure on said tottle container,
fluidically communicating a vent opening in at least one of said tottle closure and said tottle container to a location adjacent said end wall of said tottle container,
permitting air to vent through said vent opening into said tottle container,
preventing air and said fluid product from escaping out said vent opening.

8. The method set forth in claim 7 wherein said step of fluidically communicating includes fluidically communicating said vent opening to a space between said fluid product and said end wall of said tottle container.

9. The method set forth in claim 7 wherein said step of fluidically communicating includes providing a tube having a first end adjacent said vent opening and a second end adjacent said end wall of said container.

10. The method set forth in claim 9 wherein said steps of permitting and preventing include providing a disk valve between said fixed end of said tube and said vent opening.

11. The method set forth in claim 10 wherein said step of providing said tube includes providing at least one opening in a sidewall of said tube at said opposite end.
